(19) United States
(12) Patent Application Publication
(10) Pub. No.: US 2016/0196772 A1
(43) Pub. Date: Jul. 7, 2016

(54) BARRIER APPARATUS FOR SUPPORTING A FLEXIBLE BANNER

(71) Applicant: Roller Signs Limited, Tortola (GB)

(72) Inventor: Robert LEWIS, Sussex (GB)

(21) Appl. No.: 15/070,216

(22) Filed: Mar. 15, 2016

Related U.S. Application Data
(63) Continuation of application No. 13/392,333, filed on May 21, 2012, now abandoned.

(30) Foreign Application Priority Data
Aug. 25, 2009 (GB) 0914812.3

(51) Int. Cl. G09F 17/00; E01F 13/00; F16M 13/02

(52) U.S. Cl. CPC G09F 17/00; F16M 13/02; E01F 13/00

(57) ABSTRACT

Banner apparatus (10) for supporting a flexible banner (16), the apparatus comprising a spindle and an attachment element attached to the spindle and arranged to enable the flexible banner to be releasably coupled to the spindle.

It is known to use partitioning apparatus such as crowd management barriers, commonly referred to as post and webbing barriers, to partition areas of floor space. For example, post and webbing barriers may be used to partition a queuing conduit at an airport, or to partition a seating area outside a café or restaurant.

Post and webbing barriers generally comprise a base supporting an upstanding post, at a head region of which there is provided extensible webbing. The head region of each post includes one or more clips to which the extensible webbing from another post and webbing barrier can be coupled, such that a plurality of post and webbing barriers can be connected together to form a partitioning structure.

The inventor has identified a problem with known partitioning apparatus of this type in that the resultant partitioning structure does not present much in the way of a visible obstruction, nor does the webbing itself constitute a difficult obstacle for a person to pass. Furthermore, the inventor has identified that it would be advantageous to increase the visibility of such partitioning structures. The inventor has also identified that it would be advantageous to utilise parts of the partitioning structure for another purpose, such as providing information relevant to the location of the partitioning structure.

In accordance with a first aspect of the present invention there is provided barrier apparatus for supporting a flexible banner, the apparatus comprising, a spindle and an attachment element attached to the spindle and arranged to enable the flexible banner to be releasably coupled to the spindle.

Thus, apparatus according to the first aspect of the present invention enables different flexible banners to be removably attached to a spindle. The attachment element is connected to the spindle and consequently can be moved by it. As such, the apparatus according to this aspect of the present invention enables different banners to be attached to spindle such that a suitable banner can be chosen for a particular location and/or time and the banner can be wound around the spindle when not in use. A banner may be a solid sheet of material, such as a plastics material or fabric, or may be a flexible electronics device such as a flexible liquid crystal display screen.

The barrier apparatus may comprise a body arranged to rotatably carry the spindle.

The barrier apparatus may be arranged such that rotation of the spindle in a first direction causes the banner to be wound around it.

Thus, a banner can be wound around the spindle, for example when not in use.

The attachment element may be arranged to be accessible when the banner is unwound from the spindle.

Thus, when the banner is substantially fully unwound from the spindle the attachment element becomes accessible, thereby enabling the banner to be removed and/or replaced.

The attachment element may comprise a flexible member connected at one side or end thereof to the spindle, such that it can be at least partially wound around and unwound from the spindle.

Thus, the attachment element can be rolled around at least some of the spindle, which may result in a compact stowing configuration of a banner.

The attachment element may comprise a coupling formation spaced from the side or end connected to the spindle, the coupling formation being arranged to couple with a complementary coupling formation of the banner.

Thus, the attachment element acts as a spacer between the banner and spindle. This can result in the coupling formation being more readily accessible during removal and/or replacement of a banner.

The barrier apparatus may comprise a locking mechanism operable to lock the spindle so as to inhibit rotation thereof in the first direction.

This may assist in terms of preventing the coupling formation moving to an inaccessible configuration during removal and/or replacement.

The barrier apparatus may comprise biasing means arranged to urge the spindle to rotate in the first direction.

Thus, the apparatus may be arranged to roll the banner around the spindle, which may assist in stowing the banner when the apparatus is not in use.

The locking mechanism may be arranged to permit a portion of the attachment element to be unwound from the spindle due to an unwinding force and, upon removal of the unwinding force, lock the apparatus in a position or condition in which the portion of the attachment element is accessible. The portion may include the coupling formation.

The apparatus may be arranged such that rotation of the spindle in the second direction due to an unwinding force exceeding a predefined threshold causes the locking element to unlock, thereby permitting the biasing means to rotate the spindle in the first direction.

The barrier apparatus may further comprise an anchoring element arranged to be anchored to a support structure, the anchoring element further being arranged to releasably couple to a free end region of the flexible banner.

The barrier apparatus may be configured such that, in use, the anchoring element supports the banner and body.

The body may be arranged to be supported by one or more support elements, such that, in use, the body supports the banner.

The body may define a chamber within which the spindle is housed, the body having an opening via which the attachment element may pass or may be accessed.

Thus, the body may at least partially encapsulate the banner, when stowed, to reduce the likelihood of it getting dirty or damaged.

According to a second aspect of the present invention there is provided a support post adaptor for a support post having a barrier member which is extensible from a head region thereof, the support post adapter comprising a body arranged to be mounted on the head region of the post, the body having an engagement formation arranged to releasably connect apparatus for supporting a flexible banner to the body and an opening arranged to accommodate the barrier member.

Thus, an adapter may be provided on a post to enable it to carry apparatus according to the first aspect of the invention, which may in some cases be too heavy for a conventional post.

An opening of the adapter accommodates the barrier member such that the adapter does not interfere with the normal working of the post.

The body may comprise a generally cylindrical body having a closed head portion and open bottom, so as to define a cavity for receiving the head portion of the post.

The apparatus for supporting a flexible banner may be barrier apparatus for supporting a flexible banner according to the first aspect of the present invention.

According to a third aspect of the present invention there is provided barrier apparatus comprising: apparatus for supporting a flexible banner; one or more support structures; one or more support structure adapters arranged to be mounted on the respective support structures and in turn carry the apparatus for supporting a flexible banner; and an anchoring element arranged to be attached to part of the flexible banner.

The apparatus for supporting a flexible member may be barrier apparatus according to the first aspect of the present invention.

The one or more support structure adapters may be support post adapters according to the second aspect of the present invention.

These and other aspects of the present invention will be apparent from, and clarified with reference to, the embodiments described herein.

Embodiments of the present invention will now be described, by way of non-limiting example only, with reference to the accompanying drawings, in which:

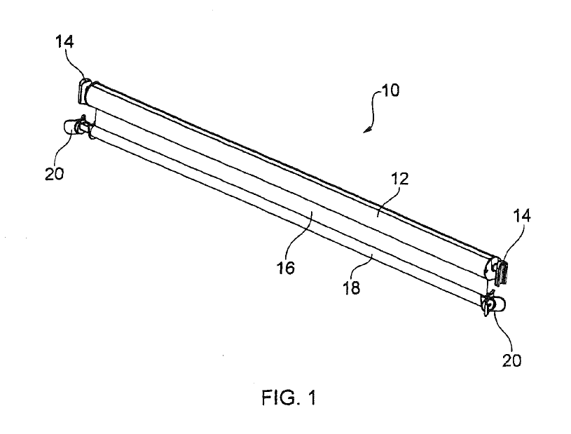

FIG. 1 shows a perspective view of apparatus for supporting a flexible banner according to an embodiment of the present invention;

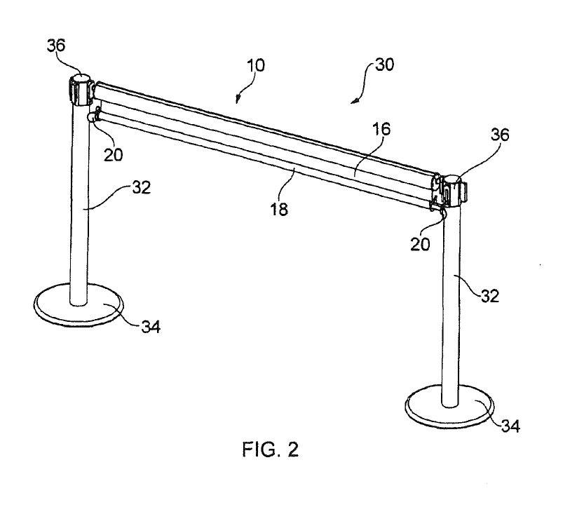

FIG. 2 shows a perspective view of barrier apparatus according to an embodiment of the present invention, including the apparatus for supporting a flexible banner shown in FIG. 1 in a retracted state;

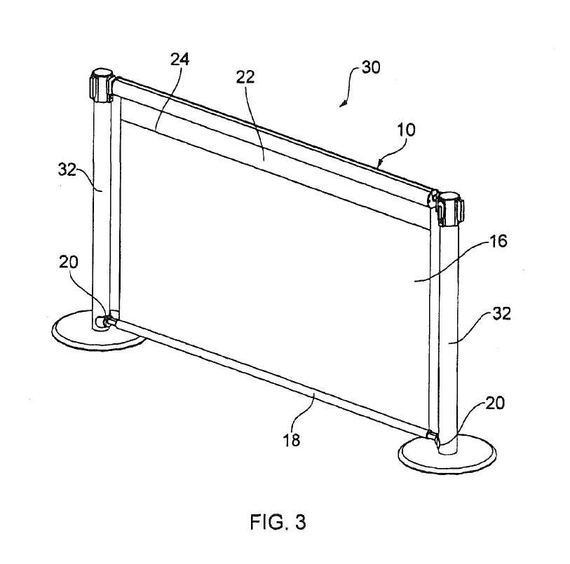

FIG. 3 shows the apparatus of FIG. 2 with the apparatus for supporting a flexible barrier in an extended state;

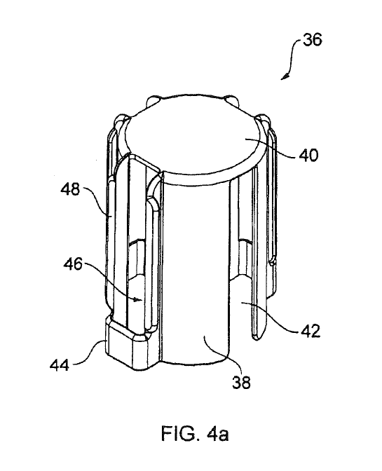

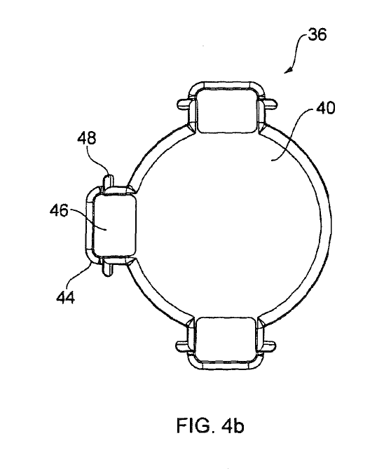

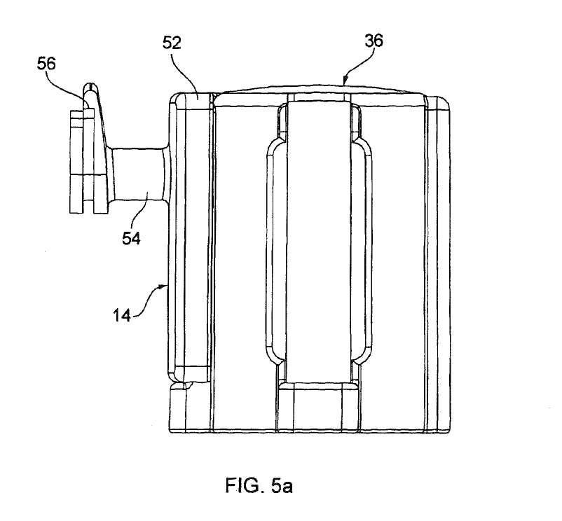

FIGS. 4a and 4b, show, respectively, a perspective view and plan view of a support post adapter according to an embodiment of the present invention; and

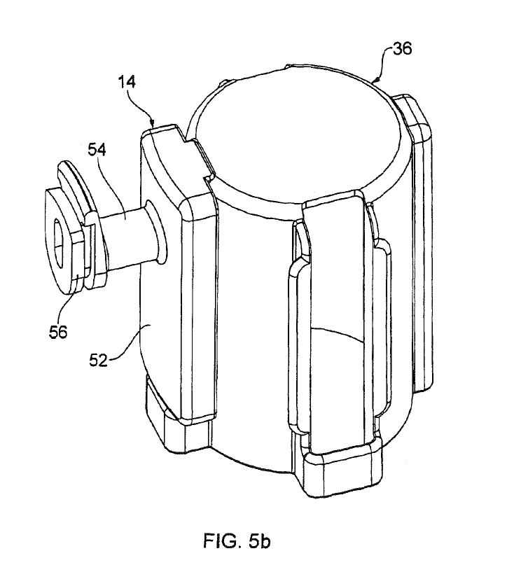

FIGS. 5a and 5b show, respectively, a side view and perspective view of the support post adapter of FIGS. 4a and 4b, having a clip of the apparatus of FIG. 1 connected to it.

Referring to FIG. 1, apparatus 10 for supporting a flexible banner according to embodiments of the present invention is shown. The apparatus 10 comprises a cross member 12 arranged to be supported by two support elements (not shown), such as posts. The cross member 12 is generally cylindrical in shape, having closed ends at which are provided clips 14. The clips 14 are arranged to connect the apparatus 10 to a pair of support elements. The cross member 12 is hollow so as to define a cavity therein. A spindle (not shown) is carried by the cross member 12. In some embodiments, the clips 14 of the cross member 12 carry the spindle, the clips being connected to the respective ends of the hollow cylindrical body of the cross member 12. The cross member 12 includes an opening (not shown) arranged to accommodate the flexible banner 16 and in some cases, an attachment element by means of which the flexible banner 16 can be attached to the spindle carried by the cross member. The attachment element and flexible barrier 16 may therefore at least partially pass through the opening. The spindle is provided within the cavity and is rotatably mounted with respect to the cross member 12. The spindle is connected to the attachment element (not shown), which in turn is arranged to be removably coupled to a flexible barrier 16, which may be, for example, an advertising banner. In the illustrated example, the attachment element comprises a flexible member (not shown) connected at one side or end thereof to the spindle, such that it can be at least partially wound around and unwound from the spindle. The flexible member of the attachment element is provided with a coupling formation spaced from the side of the attachment element which is connected to the spindle. The coupling formation in this example is a female part of a tongue and groove connector arranged to receive a male part of a tongue and groove connector provided on an advertising banner, such that the advertising banner can be releasably coupled to the attachment element. It should be noted that any suitable coupling element may be provided, non-limiting examples being a hook and eye fastening such as Velcro®, one or more clips, a yieldable adhesive, or the like.

Whilst in the illustrated example the attachment element comprises a flexible member, in other embodiments the attachment element may be provided directly on or adjacent the spindle, for example, a connector or clip provided on the circumferential wall of the spindle. In such a case it is however advantageous that the attachment element can be readily and easily accessible by a user, for example, a region of the housing defined by the cross member 12 being arranged to be opened to permit access thereto or having an opening formed therein to allow such access for the purpose of removably coupling a flexible banner to the spindle.

The apparatus 10 is arranged such that rotation of the spindle in a first direction causes the flexible banner 16 to be wound around the spindle, so as to retract the flexible banner 16 into the cross member 12. Conversely, rotation of the spindle in an opposite second direction causes the flexible banner 16 to be deployed from the cross member 12.

The apparatus 10 in the illustrated example comprises a locking mechanism operable to lock the spindle so as to inhibit rotation thereof in the first direction. However, it should be noted that in other embodiments a locking element may act on other parts of the apparatus to inhibit deployment and/or retraction of the banner. In some embodiments, the locking mechanism may be such that the flexible banner 16 may be deployed to a first position, in which the apparatus 10 is in a first configuration, whereupon the locking mechanism locks so as to prevent the banner 16 being wound back onto the spindle. A tensile unwinding force applied to the banner 16 in a downwards direction may disengage the locking mechanism so as to permit the banner 16 to be wound back around the spindle. In this sense, the locking mechanism is akin to those found in conventional roller blinds such that the banner 16 can be locked at various degrees of deployment from the cross member 12. However, any suitable locking mechanism may be provided and it should be noted that some embodiments may not include a locking mechanism.

In the illustrated example, a biasing means is provided to bias the spindle towards rotation in the first direction, such that, in the absence of other forces, the spindle rotates in a direction such that the banner 16 is wound onto the spindle. Any suitable biasing means may be provided, such as a coil spring or the like and many suitable biasing means will be apparent to a skilled person. It should be noted that a biasing means is an optional feature that may be omitted from certain embodiments.

An anchoring element 18 can be attached to part of the barrier 16. The anchoring element in this example 18 comprises an elongate body including a pair of clamps 20 disposed at respective ends thereof, the clamps 20 being movable to enable engagement of the anchoring element 18 with a structure, such as a support post. The anchoring element may be used to fix the lower end of a banner to inhibit the banner swinging, in particular about the longitudinal axis of the cross member 12. It should however be noted that an anchoring element 18 need not always be used in conjunction with apparatus for supporting a flexible banner 10.

Referring to FIG. 2, a barrier apparatus 30 is shown according to an embodiment of the present invention. The barrier apparatus 30 comprises apparatus 10 for supporting a flexible banner 16, which in the illustrated example is the apparatus 10 of FIG. 1. The apparatus 10 is carried by a pair of support post adapters 36 according to an embodiment of the present invention. The clips 14 of the cross member 12 of the apparatus 10 are engaged with the support post adapters 36. The support post adapters 36 are shown mounted on respective support posts 32. The support posts 32 are held in a generally upright configuration by respective bases 34. The support post adapters 36 are described in more detail with reference to FIGS. 4a to 5b. As shown in FIG. 2, the flexible barrier 16 is in a generally stowed configuration in which a major portion of the barrier 16 is wound around the spindle inside the cross member 12.

Referring to FIG. 3, the barrier apparatus 30 of FIG. 2 is shown with the apparatus 10 in a coupling and decoupling configuration. The flexible banner 16 is in a fully deployed configuration in which it has been withdrawn from the cross member 12 in its entirety. The attachment element 22 protrudes from the cross member 12 through the opening, such that the coupling formation 24 is accessible. The coupling formation 24 extends from substantially one end of the attachment element 22 to the other and is generally parallel with respect to and spaced from the longitudinal axis of the cross member 10. However, as noted above, any suitable coupling formation may be provided.

The anchoring element 18 is shown connected to the free end of the flexible banner 16, with its clamps 20 extended so as to be in contact with the respective posts 32. In some embodiments, where the posts 32 are formed from certain types of metal, the clamp elements 20 may include a magnet such that they each are attracted to the posts so as to maintain the position relative to the posts 32 and inhibit movement therefrom. In other embodiments, the clamp elements may include means by which to frictionally engage with the posts or any other suitable means by which to anchor the anchoring element 18 to a part of the apparatus 30. In some embodiments the anchor element 18 may define a cavity arranged to receive the cross member 12 such that it may be stored therein, for example when not in use.

In use, the flexible banner 16 may be withdrawn from the cross member 12 from a generally stowed configuration, as shown in FIG. 2, to a deployed configuration whereby the majority of the banner 16 is deployed from the cross member 12 but the attachment element 22 with the coupling formation 24 remains housed within the cross member 10. In some embodiments the banner may be locked at this position by means of a locking mechanism and/or its bottom portion anchored relative to the apparatus using the anchor element 18.

From the deployed configuration, a user may either return the apparatus to a stowed configuration by causing or allowing the banner 16 to be wound around the spindle, in some embodiments under the influence of the biasing means. Alternatively, should a user wish to switch the flexible banner 16 with another flexible banner, he or she may draw the banner 16 further out of the cross member 12 to a coupling and decoupling configuration, as shown in FIG. 3. It is advantageous that when the flexible banner 16 has been deployed to an extent that the coupling formation 24 of the attachment element 22 is visible and accessible from the outside of the cross member 12, the apparatus can be locked by a locking element, for example to lock the spindle, so as to prevent the attachment element 22 from winding back around the spindle. A user may then decouple the banner 16 from the attachment element 22 and replace it with another banner 16. Once the new banner 16 is coupled to the attachment element 22 the locking element may be disengaged, for example by applying an unwinding force above a predetermined threshold so as to decouple the locking element and thereafter the new banner 16, along with the attachment element 22 may be wound around the spindle to, for example, the deployed configuration.

In some embodiments, the apparatus 10 may further comprise a winding mechanism which may be accessible from the exterior of the cross member 12, to enable the attachment element 14 to be put into an accessible configuration should it be unintentionally moved to an inaccessible configuration, for example.

The apparatus 30, 10 for supporting the flexible banner according to embodiments of the invention therefore enables a visible physical barrier to be easily and quickly erected and enables different flexible banners 16 to be attached to the apparatus 10, which may be desirable for advertising purposes, for example.

Advantageously, when the apparatus 30 is disassembled for storage or the like, the banner 16 may be wound onto the spindle so as to be generally encapsulated by the cross member 12, so as to prevent the banner 16 becoming damaged, or dirty, or the like. The cross member 12 can, in some embodiments of the present invention, be considered to be a “cassette” from which the banner 16 can be retractably deployed and replaced as desired with another banner.

Whilst in the embodiments described above the banner display apparatus includes a cross member that is arranged to be supported such that a banner can be deployed therefrom, in another embodiment the apparatus may be arranged such that, in use, the cross member is suspended by the banner. In such an embodiment an anchoring element, arranged to be attached to the free end region of the banner, may be configured to be supported by one or more support structures, such as support posts. Thus the cross member and spindle are supported by the banner. The cross member may include clamps or the like to enable it to be anchored to a support structure to stabilise the lower end of the apparatus in use. It will be appreciated that in such an embodiment the functions of the cross member 12 and anchor member 18 of the apparatus 10 have generally been reversed. The anchoring element may be a hollow cylinder or the like arranged to receive the cross member and stowed banner when the apparatus is dismantled. In some embodiments the cross member may be omitted such that only a banner and spindle are supported by the anchoring element.

In another embodiment the cross member may be similar to the cross member 12 but arranged to be supported by a base in a generally upright configuration i.e. its longitudinal axis is generally vertical. The banner may thus be deployed horizontally to form a barrier or the like. The free end of the banner may be arranged to be attached to a support structure, such as a support post, wall or the like.

In another embodiment the cross member may be omitted entirely, such that the spindle is rotatably mounted with respect to a support element. In this embodiment the spindle may be supported, for example by a support post, such that the banner can be deployed from the spindle. As described above, in this embodiment an anchoring element may be provided, in some cases comprising a hollow tube in which the spindle and banner may be stowed (in a wound-up configuration) for storage, transport or the like.

The banner in any of the described embodiments may be of any suitable flexible material, such as a plastics material, a fabric or combination of fabrics, a flexible electronics device such as a liquid crystal display device or the like.

Referring to FIGS. 4a and 4b, a support post adapter 36 is shown according to an embodiment of the present invention. Typical post and webbing barriers comprise a generally upstanding support post having a barrier member which is extensible from the head region thereof. The inventor has identified that the head region of such post and webbing barrier posts are in some cases not strong enough to support the apparatus 10 according to embodiments of the present invention. Consequently, a support post adapter 36 comprises a generally cylindrical body 38 having a closed top 40 and an open bottom for receiving the head portion of a support post 32. The body 38 may be unitary. The support post adapter 36 includes an engagement formation 46 by which a clip 14, or the like, of apparatus 10 can be releasably connected to the body 38. In the illustrated example the engagement formation comprises a pair of elongate flanged rails 48 provided in parallel relation along the body 38. The flanged rails 48 terminate in an enlarged base 44. The arrangement of the engagement formation 46 is such that clips 14 or the like including a complementary female profile may be slidably connected to the engagement formation 46 until a part thereof abuts the enlarged base 44.

As shown in FIGS. 5a and 5b, a clip 14 can be connected to the body of the support post adapter 36. The clip 14 comprises a body 52 including a female engagement profile which is complementary to the engagement formation 46 of the support post adapter 36. A neck region 54 extends outwardly of the body 52 and terminates in a head formation 56 arranged to be attached to the cross member 12 of the apparatus 10 of FIG. 1, so as to support it in use. The clip 14 is arranged to slot into a generally circular member (not shown) that is in turn arranged to be partially received within an end of the hollow cylindrical housing of the cross member 12 and may be attached to it. The clip 14 in this embodiment has a recess arranged to receive the end of the spindle. Thus, the clip 14 forms part of the cross member 12. In other embodiments another part of the cross member 12 may be arranged to carry the spindle and the clip 14 or the like may be arranged to releasably connect to the cross member 12 or other part of the apparatus 10 to connect it to the support post adaptor 36.

The support post adapter 36 further includes an opening 42 arranged to accommodate the barrier webbing of a typical post and webbing barrier, such that the extensible webbing can be withdrawn from the post, through the opening 42, in the event the user wishes to use extensible webbing along side the apparatus according to an embodiment of the present invention. For this reason, the engagement formation 46 includes an opening, such that two standard post and webbing barriers can be connected together in a conventional fashion whilst having support post adapters 36 according to embodiments of the invention attached thereto.

A support post adapter 36 according to embodiments of the invention therefore provides a means by which to adapt conventional post and webbing barriers to a support post suitable for and arranged to support apparatus for supporting a flexible banner 10 according to embodiments of the present invention. In some embodiments, an adapter 36 may include a single engagement formation 46 and in other embodiments a plurality of engagement formalities 46 may be provided, in some cases at regular angular spacing around the side wall of the adapter 36. Engagement formations 46 may or may not include openings to accommodate the barrier webbing of anchor post. Whilst the adaptor 36 in the illustrated example is shown in conjunction with a support port, in other embodiments the adaptor may be arranged to be used in conjunction with any suitable support structure, such as a wall, to maintain the position of the adaptor 36 such that it may, in turn, support apparatus 10 according to embodiments of the present invention.

The described apparatus according to embodiments of the invention can be formed of any suitable material. It is preferred that all external parts are formed of materials that will not rust, such as a non-ferrous metal like aluminium, or a plastics material.

1-29. (canceled)

30. A support post adaptor arranged to convert a ‘post and webbing’ type support post having a barrier member which is extensible from a head region thereof into a support post that is capable of carrying apparatus for supporting a flexible banner, the support post adapter comprising a body arranged to be mounted on the head region of the support post, the body defining an opening and a cavity for receiving the head region of the support post, the body including a clip which protrudes from the body and defines an engagement formation for engaging with a corresponding engagement formation on the apparatus for supporting a flexible banner so as to support one end of the apparatus for supporting a flexible banner, and an opening which is larger in cross section than the extensible barrier member such that the extensible barrier member can be deployed from the support post while the support post adaptor is mounted on the head region of the support post.

31. A support post adapter according to claim 30, wherein the body comprises a generally cylindrical body having a closed head portion and open bottom, so as to define a cavity for receiving the head portion of the post.

32. A support post adapter according to claim 30, wherein the engagement formation includes a pair of elongate flanged rails arranged to be slidably connected to the apparatus for supporting a flexible banner.

33. A support post adapter according to claim 30, wherein the body is unitary.

34. A support post adapter according to claim 30, wherein the engagement formation includes the opening.

35. A support post adapter according to claim 30, including a plurality of engagement formations.

36. A support post adapter according to claim 35, wherein the engagement formations are provided at regular angular spacing around the body.

37. A support post adapter according to claim 30, including a plurality of openings.

38. A support post adaptor for increasing the functionality of a support post, the support post including a coiled length of flexible barrier webbing mounted on a rotatable cassette within a housing define by a head region of the support post, with a free end of the flexible barrier webbing protruding through a slot in the head region of the support post such that the flexible webbing can be extended from the head region by pulling the free end of the flexible barrier webbing, the support post adapter comprising a body having an open bottom so as to define a cavity for receiving the head region of the support post, the body including a clip and an elongate slot which opens onto the open bottom of the body such that the free end of flexible barrier webbing can be received by the elongate slot when the support post adaptor is mounted on the support post and the head region of the support post is received within the cavity of the support post adaptor, wherein the support post adaptor is distinct from the head region of the support post and can be removably coupled to the head region by inserting the head region into the cavity.

39. A support post adaptor for increasing the functionality of a support post, the support post including a coiled length of flexible barrier webbing mounted on a rotatable cassette within a housing define by a head region of the support post, with a free end of the flexible barrier webbing protruding through a slot in the head region of the support post such that the flexible webbing can be extended from the head region by pulling the free end of the flexible barrier webbing, the support post adapter comprising a body having an open bottom so as to define a cavity for receiving the head region of the support post, the body including a clip and an elongate slot which opens onto the open bottom of the body such that the free end of flexible barrier webbing can be received by the elongate slot when the support post adaptor is mounted on the support post and the head region of the support post is received within the cavity of the support post adaptor, wherein the cavity is sized to provide an interference fit with the head region of the support post to removably couple the support post adaptor to the support post.
